(19) United States
(12) Patent Application Publication
(10) Pub. No.: US 2008/0256950 A1
(43) Pub. Date: Oct. 23, 2008

(54) Turbo Lag Reducer

(76) Inventor: Bret J. Park, So. Jordan, UT (US)

Correspondence Address: GLEN W. PARK, P.O. BOX 17181, SALT LAKE CITY, UT, 84117, US

(21) Appl. No.: 12/061,840

(22) Filed: Apr. 3, 2008

Related U.S. Application Data
(60) Provisional application No. 60/924,000, filed on Apr. 18, 2007.

(51) Int. Cl. F02B 33/44

(52) U.S. Cl. 60/611

(57) ABSTRACT

A turbo lag reducer is a device which compresses air into the combustion chamber of an internal combustion engine (providing boost), and does so without the revolution speed restrictions of typical turbo- and super-charger devices. A turbo lag reducer device includes several portions or sections. A common impeller compressor device, an exhaust gas-driven turbine driving device, a mechanically-rotated transmission portion (operably connected to receive and transfer engine rotational movement from the engine to the impeller) and a clutch device. The turbine and the transmission device are both powered by the internal combustion engine into which the turbo lag reducer compresses air. The turbine is driven by high pressure exhaust gasses from the engine's combustion chamber, and also by a transmission device that is mechanically driven from the same engine. The transmission device is operably coupled to an engine and the clutch device (possible a unidirectional, overriding clutch and/or electrical or hydraulic switch type clutch) so as to rotate the clutch device of the turbo lag reducer, which is operably coupled to an impeller compressor. The impeller compressor is thereby caused to rotate by both exhaust flow from the engine's combustion chamber, as well as, by the mechanical rotation of the engine through the transmission device, with the clutch, configured so as to allow or cause either exhaust flow or mechanical means, to supercede the other as is needed to achieve the desired turbo boost, or the desired amount of compressed air for the engine's combustion chamber.

### CROSS-REFERENCE TO RELATED APPLICATIONS

This application claims the priority benefit of U.S. Provisional Patent Application No. 60/924,000 dated Apr. 18, 2007 and titled Turbo lag reducer.

### APPENDICES

None.

### TECHNICAL FIELD

The present invention relates generally to turbo charger booster and super charger devices for use with internal combustion engines.

### BACKGROUND

Description of Related Art

Turbo charger devices are well known in the field of motorized vehicles for increasing the speed, acceleration and power generated by an engine. However, at those times when engine throttle or engine rotational speed or revolutions per minute (RPMs) are low, or relatively low, or when the engine has a low load, there is a lag and/or delay in time between when the turbo boost (higher than atmospheric pressure between the impeller and the combustion chamber) from a turbo charger is desired, and/or more efficient, and when a substantial boost actually occurs. At such times, although there is an initial acceleration of engine RPMS, it is significantly slower and lower than when the prior art finally produces its boost, and the engine's power rapidly increases. This lag time can be from approximately a fraction of a second to several seconds in duration. There are primarily the following situations in engines when such low throttle or RPMs routinely occur: (i) When an engine is in an idling mode (at low RPMs); (ii) When an engine is in a low load situation at any given RPM; and (iii) (In a limited application for engines, an engine can be specifically applied to a vehicle), When a vehicle is shifting from one gear (gear ratio) to another. Since the engine's RPMs drop to relatively low levels and load is released from the engine at these times, the turbo charger is producing minimal, if any, boost to the engine's combustion chamber.

The need to optimize the horsepower, efficiency, speed and acceleration of engines has motivated the development of many different turbo charger devices, including those known as turbo chargers and others known in the field as super chargers. Both turbo chargers and super chargers produce a boost in airflow and air pressure to the engine's combustion chamber(s), which results in a desired, although delayed, increase in horsepower, efficiency, speed and acceleration.

A turbo charger is known in the field to produce that boost in airflow by utilizing the flow of exhaust gases from the engine which, by various means, ultimately power (rotate) an impeller, which herein means a fan-like air pump/air compressor apparatus, in the turbo charger, which draws in outside air (at atmospheric pressure), and that may push and compress that air to higher than atmospheric pressure, and forces that outside air to the combustion chamber of an engine (including the engine's intake manifold). This increased airflow results in increased engine output (RPMS, acceleration, efficiency and horsepower). Thus, a turbo charger is exhaust-gas driven, and not mechanically driven.

A super charger is known in the field to produce a similar boost in airflow by mechanically utilizing power tapped from the engine by means of operably coupling to the engine to receive rotational motion, usually by means of a pulley or other similar device, which is connected to one of the pulleys, belts or belt systems at, or near, the front of the engine (these pulleys, belts, etc., being a transmission device, transferring power from the engine to the supercharger) to power (rotate) an impeller, twin-screw or other type of air-pump, air-compressing device, which draws in outside air and forces or compresses that outside air to the engine's combustion chamber(s), with a similar result of increasing engine output (RPMS, acceleration, efficiency and power). Thus, a super charger is mechanically driven, not exhaust driven.

In both turbo chargers and super chargers, there is a similar lag in time between when the boost in engine output is sought and when it actually occurs.

This lag in power boost occurs because super chargers and turbo chargers both have a limited range of RPMs and speed in which they can effectively operate. In other words, they cannot effectively operate from low RPMs and speeds all along the spectrum to the highest RPMs and speeds. They can only effectively operate in a portion of that range. If super chargers and turbo chargers were used to increase outside airflow at and from low engine RPMS, then at some point when the engine's RPMs reach a certain speed (which may vary in exact level from one application to another), existing super chargers and turbo chargers actually cease to provide beneficial results, and they begin to serve as a drag or limit on the upper reaches of boost, speed, acceleration and power that could otherwise be achieved within the limited range in which the super charger or turbo charger can function and produce power boost.

Likewise, if they were used to increase outside airflow at and to high engine RPMS, then for a range of low engine RPMS, up to some point of relatively higher engine RPMS, such existing super chargers and turbo chargers would not provide the desired beneficial results.

Because of this either/or circumstance in super chargers and turbo chargers, either having the boost at lower RPMs or at higher ones, but not at both or all ranges, a choice must be made as to where to have that boost occur. Since it is generally considered by most users to be more important to have the beneficial boost at the higher RPMS, super chargers and turbo chargers, opting to employ their limited range of boost at higher RPM levels, have power lag at lower RPMs.

Thus, a need exists to effectively increase the range over which super chargers and turbo chargers provide boost, thereby allowing for the low RPM/low load turbo lag to be reduced or eliminated, as well as, allowing the engine at higher range of RPMs to benefit from the boost.

Certain devices have been conceived that combine the principles of a turbo charger and a supercharger in an attempt to increase the range over which a vehicle can produce boost to the engine.

For example, the following U.S. patents disclose various systems which use two separate impellers to combine a turbocharged engine with an engine driven supercharger: U.S. Pat. Nos. 2,296,268; 4,5045,117; 4,903,488 and 6,343,473. As mentioned, these various devices are characterized by having two separate air compressors, one incorporated in the supercharger aspect of the device and one incorporated in the turbo charger aspect of the device.

Having two separate air compressor devices causes an increased cost for the device, when compared to the turbo lag reducer device, which needs only one air compressor device, but may have more. Also having multiple air compressor devices substantially increases the number of moving parts, hence the complexity, of these prior art devices, when compared to the turbo lag reducer device. More importantly, the smoothness in switching between the boosting of the supercharger to the boosting of the turbo charger is very poor, i.e., such switching is not very smooth in the systems described.

Additionally, a motor-assisted turbocharger, which also combines elements of a turbo charger and a supercharger, has been conceived. Essentially, an air compressor, incorporated in the turbo charger, is powered by the exhaust gases at higher RPM's and is powered at lower RPM's by a separate electrical motor, connected to the connecting shaft of the turbo charger. The following patents are examples of this type of system: U.S. Pat. Nos. 4,850,193; 4,882,905; 4,894,991; 4,882,905.

This type of hybrid system, which uses an electric assist motor, is characterized by additional costs for including a separate motor as well as a need for an additional power source for said motor.

The objective of the turbo lag reducer device of this application is to effectively increase the range over which turbo chargers provide a boost without the drawbacks of substantially increased cost (due to increased number of parts and/or devices), and lack of smoothness that characterize the alternative devices mentioned above. To accomplish this purpose, this device is novel in combining the elements of a turbo charger and a supercharger by using a single/common air compressor impeller device similar to that found in a turbo charger, which is also driven by mechanical means from the engine from which exhaust gas is a byproduct. A unidirectional clutch (also known as one-way, slip-clutch, or over riding clutch) is the preferred means by which the exhaust means are superceded by the mechanical means and visa versa.

### BRIEF DESCRIPTION OF THE DRAWINGS

FIG. 1 is a schematic top partially cut-away view of the turbo lag reducer device, showing a very basic overall configuration of the invention.

FIG. 2 is a schematic top cut-away view of the turbo lag reducer wherein a standard turbo charger is incorporated into the invention;

FIG. 3 is a front cut-away view of a type over riding clutch device, shown in two modes (engagement and disengagement) as well as a side cut-away view of the same device.

FIG. 4 is a side cut-away view of a type clutch device, shown in two modes (engagement and disengagement).

FIG. 5 is a front cut-away view of a ratcheting type clutch device.

FIG. 6 is a front cut-away view of a “sprague” one-way type clutch device.

FIG. 7 is a 3-dimensional cut-away view of a preferred embodiment, of a portion of the turbo lag reducer device.

FIG. 8 is a 3-dimensional view of the working parts, (without the housing present) of the portion of the preferred embodiment shown in FIG. 7, of the turbo lag reducer device.

### DETAILED DESCRIPTION OF THE INVENTION

For the purposes of promoting an understanding of the invention, reference will now be made to the embodiments illustrated in the drawings and specific language will be used to describe the same. It will nevertheless be understood that no limitation of the scope of the invention is thereby intended. Any alterations and further modifications of the inventive features illustrated herein, and any additional applications of the invention as illustrated herein, which would normally occur to one skilled in the relevant art and having possession of this disclosure, are to be considered within the scope of the invention claimed.

It must be noted that, as used in this specification and the appended claims, the singular forms “a,” “an,” and “the” include plural referents unless the context clearly dictates otherwise. Moreover, as used herein, the terms “comprising,” “including,” “containing,” “characterized by,” and grammatical equivalents thereof are inclusive or open-ended terms that do not exclude additional, un-recited elements or method steps.

Applicant has designed a new turbo lag reducer device to reduce or eliminate the lag and/or delay in time between when a turbo boost is desired or needed, and when it actually occurs, by pushing additional compressed outside air into the engine's combustion chamber immediately, or almost immediately, before such boost would occur through prior art through utilizing a common impeller to combine elements of exhaust-driven and mechanically-driven means.

Further, the turbo lag reducer may push additional compressed outside air into the enclosed portion between the impeller and the combustion chamber or the intake manifold portion while the engine is idling, as well as, while the engine is operating at a constant, or near constant, RPM and speed, which may serve to increase fuel efficiency in part by achieving a more complete burning of fuel at times of relatively low engine RPMS, but consuming less fuel in the process. This more complete burning of fuel resulting from the additional air being supplied at times of low, or relatively low, RPMs and/or engine load may also serve to reduce emissions, for this additional air will enable the engine to more completely burn the fuel being supplied to the engine's combustion chambers.

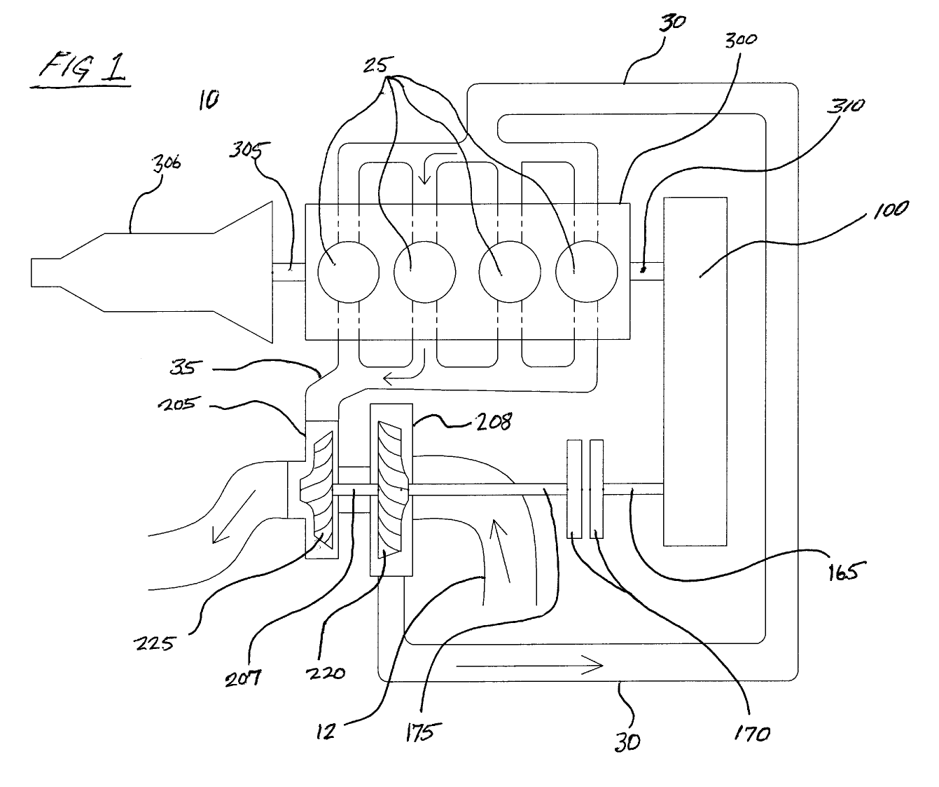

Referring now to FIG. 1, a schematic top view with sections cut-away, is shown of a turbo lag reducer device, designated generally as 10, wherein there is an engine 300, having internal combustion chambers 25, being of a standard internal combustion engine design known in the art. Connected to the combustion chambers are the enclosed tubular devices or intake and exhaust manifold systems designated as 30 and 35, wherein intake manifold 30 carries the fresh air, sometimes mixed with fuel, to the combustion chamber(s) (manifold 30 comprising all enclosed tubular devices including any intercooler devices known in the art, between impeller 220 and combustion chamber(s) 25), and wherein exhaust manifold 35 carries the exhaust gasses out of the combustion chamber. Engine 300 produces rotational motion and energy, said rotational energy is carried from the engine by means of output shafts 305 and 310 (the output shafts may be different or the same shaft). The engine output shaft 305 is attached to a transmission device 306 which enables rotational motion to be taken from engine 300 and power some vehicle or device (which may be used for any number of applications, and said transmission device 306 is involved only to transfer engine 300 output to devices outside of the current invention, and not to be confused with transmission device 100). There is attached to the exhaust manifold 35, a housing 205, which housing encases a turbine 225. Said turbine 225, which is a fan-like apparatus, is caused to rotate by the exhaust gasses produced in combustion chamber(s) 25. Turbine is coupled to shaft 207, which is coupled to an impeller air-compressing/air-pump device 220, which impeller 220 is enclosed by housing 208. By means of this coupling turbine 225 forces impeller 220 to rotate, causing impeller 220 to draw in outside fresh air through tubular device 12 and then compress and force air through manifold system 30 into combustion chamber(s) 25, wherein combustion occurs producing high pressure exhaust gasses, which then are released into exhaust manifold 35. There is also a transmission device 100 coupled in any manner known in the art to output shaft 310 to receive rotational motion from engine 300 at a given speed or revolutions per minute (RPM), which then takes this rotational motion and changes the RPM's and transfers this motion at the possibly different RPM's to the transmission device 100 output shaft 165. Thus, there is a ratio between shaft 310 and shaft 165, which ratio may cause shaft 165 to rotate at a different RPM than shaft 310. Said ratio may be at 1 to 1, but most likely will be significantly different such as 0.1 to 1 or any other ratio, to produce the desired results from the lag reducer device 10. To achieve this RPM ratio between shafts 310 and 165, the transmission device 100 may utilize any number of means known in the art of transmissions, such as but not limited to gears, sprockets, chains, belts, pulleys, shafts, splines, etc. So long as rotational motion is transferred, and ratio between shafts 310 and 165 are maintained the means to do so is not extremely important. There is a clutch device 170, which is coupled to shaft 165, and which is also coupled to shaft 175 (the means which these shafts 165 and 175 are coupled to clutch 170 may be any means known in the art, i.e. splines, bolts, pins, keyways, weldments, etc.), wherein shaft 165 transfers rotational motion into clutch 170, and clutch 170 may transfer or force rotational motion into shaft 175 if it in an engagement mode, or clutch 170 may be in a disengagement mode wherein no motion is transferred between shaft 165 and shaft 175, allowing shaft 175 to rotate freely from shaft 165. Clutch 170 may be any clutch known in the art, however in this preferred embodiment clutch 170 is a unidirectional or over riding clutch, wherein if shaft 165 is rotating faster than shaft 175, clutch 170 forces this rotational motion into shaft 175, causing shaft 175 to rotate at least as fast as shaft 165. However if shaft 175 should rotate faster than shaft 165, this clutch 170 (occurring automatically if it be a unidirectional or over riding clutch) would allow shaft 175 to rotate at any speed faster than 165. Shaft 175 is connected to or coupled to impeller 220, which causes impeller 220 to rotate at the same speed as shaft 175, therefore rotational motion of shaft 175 causes the rotation of impeller 220, or vise versa.

The operation of the lag reducer device 10 is as follows: When engine 300 is operating such that a relatively low volume of exhaust gasses are coming from its combustion chamber(s) 25 (such as at times of low load or low engine RPM), such that turbine 225 is not being forced to rotate at a speed which would cause impeller 220 to produce boost or enough boost into manifold 30, for desired or optimal combustion in combustion chamber(s) 25, then the mechanical rotational motion of the engine 300 through shaft 310, through transmission device 100 (having the output speed be of a beneficial rate), into shaft 165, then through clutch 170 (because shaft 175 at this point would not be greater than shaft 165) into shaft 175, causes impeller 220 to rotate at a speed which would produce the desired boost. The boost produced at this time would be ultimately caused (though indirectly) by and through the mechanical rotational motion of the engine 300 through the means just described. Also at this time the impeller 220, shaft 207 and turbine 225 would be spinning at a rate faster than the exhaust gasses would normally be spinning them.

This mechanically forced rotation of the impeller would continue until such time (by means of either higher RPM's of engine 300, or higher load of engine 300, or other means wherein more exhaust gasses would be produced) when the exhaust gas volume and/or exhaust gas speed from the combustion chamber(s) 25, through exhaust manifold 35, causes turbine 225 to rotate or spin at a speed greater than that being produced by shaft 165, wherein, through shaft 207, the turbine 225 forces impeller 220 to rotate at this faster exhaust-gas-induced speed. At this time shaft 175 is spinning at a rate now higher than shaft 165, wherein clutch 170 allows this to occur, by means of a type of disengagement, or over-running action, known in the art (of clutches). During this time of turbine 225 speed being greater than shaft 165 speed, caused by the greater speed/volume of exhaust gasses, the devices 225, 207, 220 and 175 may spin as fast as the exhaust gasses cause them to.

At such time when the exhaust volume/speed decreases to the point where turbine 225 rotational speed (RPM's) is lower than the RPM's of shaft 165, clutch 170 will again be in a phase of engagement, such that shaft 175 will be forced to rotate at the same RPM as shaft 165, therein causing impeller 220 to be rotated at the same RPM as shaft 165, in which case a desired boost pressure will be produced or maintained within manifold 30 to provide combustion chamber(s) 25 with a beneficial amount of air volume and/or pressure. Thus it should be understood that impeller 220 will always be spinning at a speed which will produce beneficial results in engine 300, whether it be by the mechanically forced rotational means described, or from the exhaust gasses described.

It should also be understood that transmission 306 is the means of transferring power from the engine for whatever means the engine is being used for, and transmission device 100 is a portion of the present invention, being part of the means of powering the impeller 220. But transmission 306 may also be used as a means of transferring rotational motion into impeller 220 at which time it would part of the invention. Having transmission 306 included in the description is not part of the present invention, but was used for clarity purposes in showing that the transmission device 100 is not necessarily the means of taking power from the engine to power other devices or vehicles, but is nonetheless a transmission device transferring power from the engine into the impeller 220.

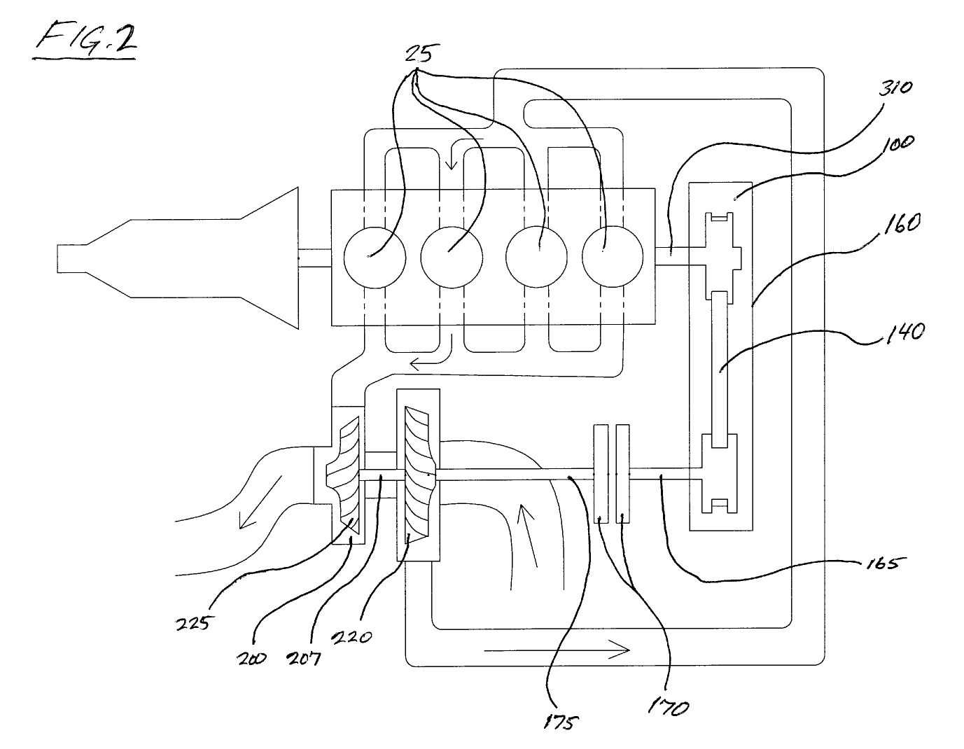

Referring now to FIG. 2, a schematic top view is shown of a turbo lag reducer, having a transmission device section, designated generally as 100. The transmission device section 100 may be positioned in a housing 160 of any variety known in the art for supporting and/or covering the transmission device section 100. The transmission device section 100 may be attached to a rotational part, generally designated, actuator 310 of an engine 300 by any suitable first rotational transfer means 104. The rotational actuator 310 of the engine can be a shaft, an alternator pulley, fan belt, alternator belt, engine, motor, shaft, disc, wheel, plate, nut, gear, other suitable device, or simply part of the crank shaft of engine 300. The attachment to the rotational actuator 310 is for the purpose of transferring power from the engine 300 to the transmission device section 100 in the form of rotational motion.

In this embodiment transmission device 100, may have two pulleys 139 and 141, wherein a belt 140 is rides between the two pulleys 139 and 141, to cause the two pulleys to rotate in some ratio together (this belt and pulley system being very common in the art of transmissions). Pulley 139 is connected to actuator 310 such that pulley 139 will be forced to rotate with actuator 310. This rotation of pulley 139 will cause belt 140 to track around both pulleys 139 and 141, and in so doing will force pulley 141 to rotate in a ratio to pulley 139.

A shaft 165 may be attached at one of its ends to the pulley 141 of the transmission device 100, to force the rotation of shaft 165 It will be appreciated that the shaft 165 may be of whatever size, shape, such as round, oblong or rectangular, or length as is within the scope of the present device. (This belt and pulley system with pulleys 139 and 141, acting with belt 140, would be very similar in working action, as would a chain and sprocket system.) It should be understood that although this embodiment uses a belt and pulley system, that transmission device 100 may include and/or use any number means to obtain a transmission of power/rotation at a given ratio between actuator 310 and shaft 165, such that shaft 165 will have a mechanically forced rotation, at a specific RPM ratio compared to that of actuator 310.

The means for attaching the shaft 165 to the pulley 141 of the transmission device 100 may include any suitable attachment means, such as nuts, splines, threads, welding, fasteners, or any other suitable means known to those skilled in the art.

The shaft 165 may also be a rod, or any other suitable means known to those skilled in the art.

The opposite end of shaft 165 may be attached to a clutch device 170 by any suitable means.

The shaft 165 may also be a rod, or any other suitable means known to those skilled in the art.

A clutch device 170 may be attached at one end of the shaft 165. The means for attaching the clutch device 170 to the shaft 165 may include any suitable attachment means, such as nuts, splines, threads, welding, bearings, fasteners, or any other suitable means known to those skilled in the art.

The clutch device 170 may also be a unidirectional clutch, mechanical diode, a Sprague clutch, a one-way clutch, an overrunning clutch, an overriding clutch, a ratcheting clutch, a physically disconnecting clutch, or any other suitable means known to those skilled in the art, and may be of whatever size or shape suitable to the present device, and the clutch device may be located on either side of the transmission device 100, but in this embodiment is attached to the output end of transmission device 100.

An additional embodiment of the invention includes the use of an electrically-controlled, or mechanically, hydraulically, or otherwise-controlled, switch in place of an overriding or unidirectional clutch 170, wherein the electrically-controlled, or mechanically, hydraulically, or otherwise-controlled switch allows/causes one rotational member to be superceded by another rotational member. In such case, the electrical switch causes frictional members, gears or other suitable means connected to the two rotational members to engage or disengage when one rotational member is superceded by the other rotational member, to work such that optimal boost is provided to combustion chamber(s) 25.

The means for attaching the rotational output shaft 175 to the clutch device 170 may include any suitable attachment means, such as nuts, splines, threads, welding, fasteners, or any other suitable means known to those skilled in the art.

A rotational output shaft 175 may be attached to the clutch device 170. It will be appreciated that the output shaft 175 may be of whatever size, shape, such as round, oblong or rectangular, or length as is within the scope of the present device. The rotational output shaft 175 may also be a rod, or any other suitable means known to those skilled in the art.

There is a turbocharger 200, being of the construction known in the art, said turbocharger 200 having at least a turbine 225, an impeller 220, a shaft 207 connecting the turbine 225 to impeller 220, all enclosed in a housing 209. Said turbocharger 200 may also have bearings, lubricating systems, gaskets, bolts, fasteners, splines, etc., all means known in the art of turbochargers to allow the proper turbocharger function.

The rotational output shaft 175 may be attached to impeller 220, which impeller 220 is common to both shafts 207 and 175 (making impeller 220 driven commonly and possibly indirectly by engine exhaust gasses and mechanical engine rotation at times either together or separately) such that the rotation of the rotational output shaft 175 may be transferred to said impeller 220 of the turbo charger 200, which causes the impeller 220 of the turbo charger 200 to rotate faster than it is, or would be, rotating as a result of the exhaust gas flow through the turbo charger 200 without mechanical driving means by virtue of shaft 175 being attached thereto. Such impeller 220 may be a common impeller that is both driven (though indirectly) by the engine rotation and/or by exhaust gas driven turbine.

An additional embodiment includes having two (2) or more separate air compressor impellers working together, but still commonly driven by both driving means one powered by the exhaust-gas and the other powered by the mechanically-driven mechanism. Any one, or two, or more air compressor impellers may be powered simultaneously.

The rotation transferred from the actuator 310 transmission device section 100, which by means of various ratios of pulleys, gears, chains, belts, transmission(s), or any other suitable means known in the art for transferring such power, may change, (likely to increase) the revolutions per minute (RPMs) over that of the rotational part of the engine 300 and ultimately transfer that rotational motion to power the impeller 220 of a turbocharger 200 with such transfer of rotational motion continuing until the exhaust flow from the engine 300 is at sufficient volume and/or pressure as to cause the turbine 225 and thus impeller 220 to supercede the RPMs of the transmission device section 100 output RPMs.

Shaft 165 and shaft 175 may be attached to a clutch device 170 such that there may be differential RPMs between shaft 165 and shaft 175 acting at either end of the clutch device 170. However when clutch 170 is in a mode of engagement (as known in the art clutches may be in either a mode of engagement where rotational motion is forcibly transferred through the clutch, or in a mode of disengagement where rotational motion is not transferred through) shaft 165 would transfer its rotational motion through the clutch to shaft 175, which would force impeller 220 to rotate at the same RPM as shaft 175. The clutch device 170 may include means for (i) engaging, wherein shafts 165 and 175 would rotate synchronously when the impeller 220, of the a turbo charger 200 is, or would otherwise be, rotating at a different speed than that of the rotational output shaft 165, and (ii) disengaging, allowing the common impeller 220 of the turbo charger 200 to supercede the rotational movement of the output shaft 165. The clutch device 170 may be designed in any suitable manner. For example, it will be appreciated that the clutch device 170 may be designed for allowing the rotational motion of the shaft 175 to supercede the rotation of the turbo charger turbine 225, during conditions of said low exhaust gas flow (and therefore RPMs of the turbine 225 would normally be low), or relatively lower than the RPMs of the shaft 165, and therefore, of said shaft 175. It is at this time when said clutch 170 would be engaged, thus transferring rotational movement directly from shaft 165 to shaft 175, and cause impeller 220 to maintain an RPM high enough to produce boost (or to maintain an RPM on impeller 220, which would have not been so high by the low exhaust gasses rotating turbine 225). When the load and/or RPMs of the engine 300 increase(s) to a point at which the exhaust flow is sufficient to cause the turbine 225 to rotate the common impeller 220 of the turbo charger 200 at approximately the same or at higher RPMs than that produced by the shaft 165, and therefore of the shaft 175, then the clutch device 170 may allow (through a type of disengagement or otherwise) the rotational motion of the impeller 220 of the turbo charger 200 to supercede the rotational speed/RPM's from the shaft 165.

When the rotational speed (RPMs) of impeller 220 of the turbo charger 200 (caused by the exhaust flow from the engine 300) decreases to a point where the RPMs of the shaft 165, are approximately the same or higher than the rotational motion of the common impeller 220 of the turbo charger 200, (caused by said exhaust flow), the clutch device 170 may allow, or engage to cause, the rotational power of the shaft 165, and therefore, of the shaft 175 to supercede the rotational power or speed of turbine 225 powered by the exhaust flow of the impeller 220 of the turbo charger 200.

The present device, will receive the rotational motion power from an engine 300 by the means described herein above, and by means of the various pulleys, belts, gears, sprockets, chains, chains and sprockets, and/or transmission(s), or of other suitable means known to those skilled in the art, to change or increase the RPMs received from the engine 300 and its output shaft 310 until the rotational speed (RPMs) of the transmission device 100 is transferred to the impeller 220 of the turbo charger 200. This transfer of rotational power to the turbo charger 200, when the engine 300 is at various ranges of low, or relatively lower, RPMS, will result in the rotational speed (RPMs) of the transmission device 100 superceding the RPMs of turbine 225 and therefore of the air compressor impeller 220 of the turbo charger 200 (which slower rotation is produced by a relatively low volume of exhaust flow from the engine 300). Such mechanically forced superceding rotational motion thus produced by the transmission device 100 will continue to supercede the rotational speed/RPMs of the turbo charger 200 until the engine 300 has increased its exhaust gas flow to a point such that the RPMs of turbine 225 being transferred to the impeller 220 by the increased exhaust flow from the engine 300 exceed the RPMs of shaft 165 or of the output of the transmission device 100, at which point, the additional boost will be produced by the normal function of the turbo charger 200, having the turbine 225 and impeller 220 then supercede the rotational speed of the shaft 165.

It will be understood that the alternating, back-and-forth process of the superceding of the normal or existing speed of rotation of the impeller 220 of the turbo charger 200 by the mechanically forced rotational motion from actuator 310, through transmission device 100, through shaft 165, through clutch 170, through shaft 175, into impeller 220, followed by the eventual superceding of this mechanically forced rotational speed by that of the exhaust-driven rotation of the turbine 225, then the superceding of the rotation of the turbine 225 by the mechanically forced rotational speed motion of the output of the turbo lag reducer transmission device section 100, will continue to occur, back and forth, based upon the RPMs and/or exhaust flow being generated by the engine 300 as it is either accelerating, or doing one of: (i) maintaining constant or near-constant speed (RPMs); or (ii) decreasing speed; or (iii) idling, or some other low, or relatively low, RPM or low load operation. The clutch device 170 is the principle means by which this alternating, back-and-forth, superceding operation is brought about. A variety of different clutch device 170 may be used in the turbo lag reducer device section 100, including, but not limited to, those as described in the various embodiments. In both embodiments shown as FIG. 1 and FIG. 2, the clutch device 170 is located in a “preferred” location, however this clutch device 170 may be located at any point between the engine 300's output shaft 310 and the impeller/compressor 220, so that the engine 300 may be either engaged or disengaged (as needed) from impeller/compressor 220.

It should be understood that the following descriptions of clutch devices is not to limit the present invention to just these types of clutches, but simply to give a general picture of some of the prior art clutches that may be used with and in the present invention. There are many types of clutches that have been invented, therefore when the word clutch or clutch device or clutch type device is used herein, it is simply referring to a device which enables two shafts to either be “engaged” wherein (i) the two shafts will be forced to spin/rotate at the same rotational speed (synchronously with each other); (ii) or to be “disengaged” wherein the two said shafts will be able to spin/rotate freely from each other with respect to their rotational speeds. Therefore, a clutch, clutch device, or clutch type device, will have two modes, an “engagement” mode, and a “disengagement” mode.

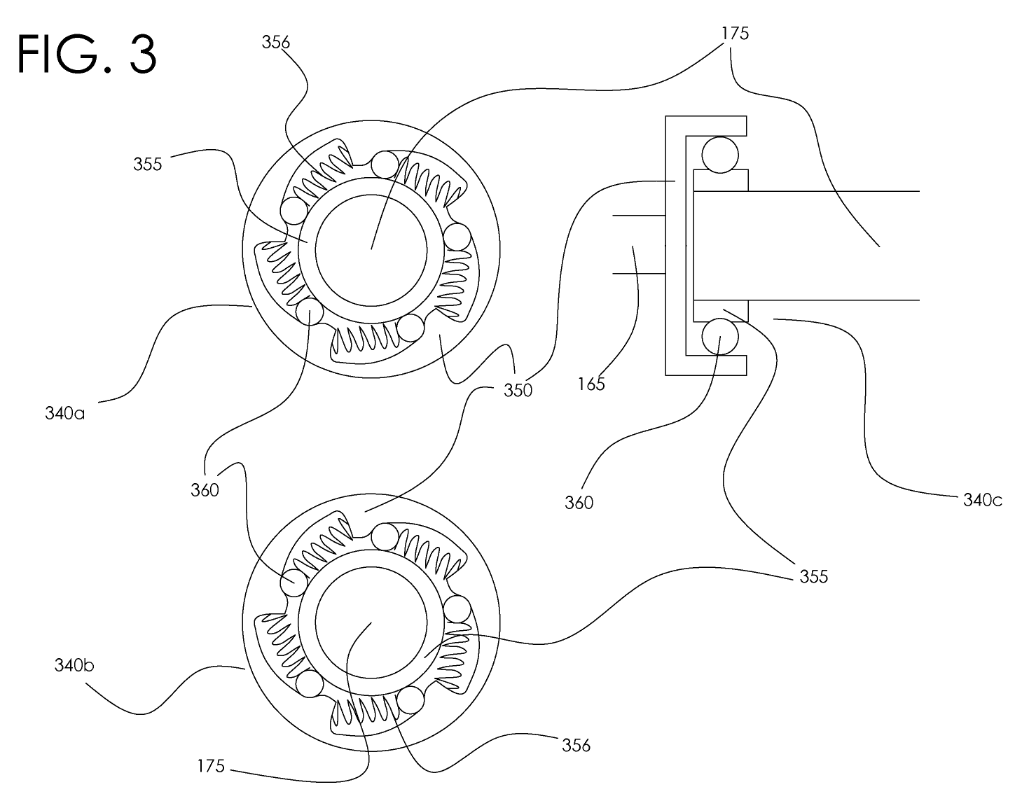

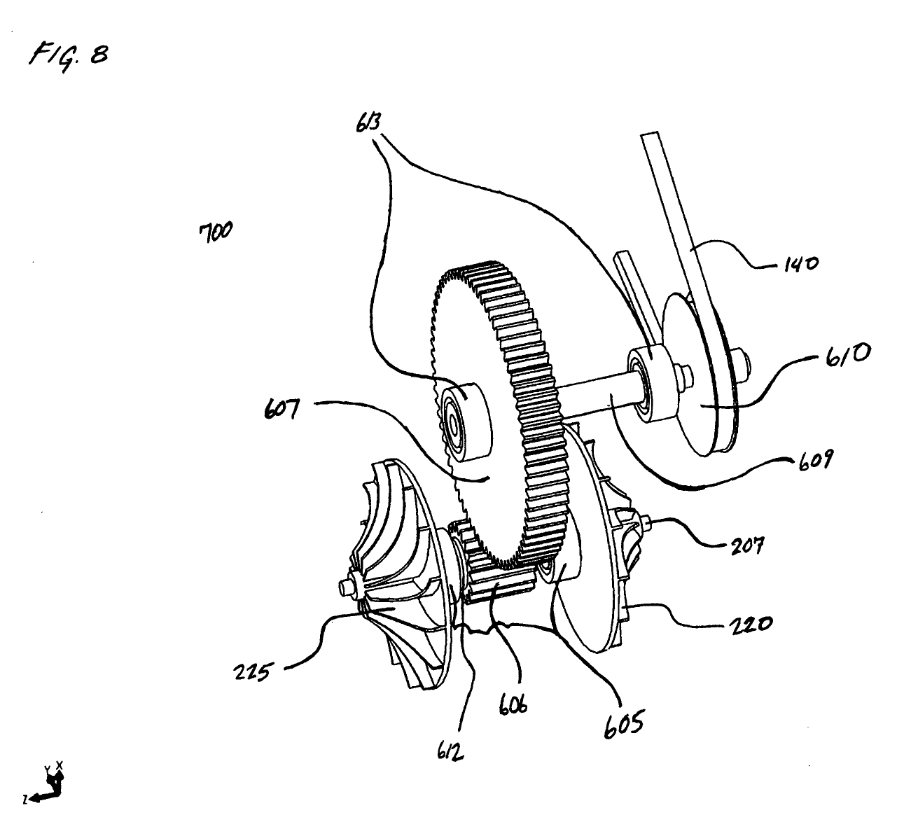

Referring now to FIG. 3. FIG. 3 is a one-way type of clutch device known in the art. This clutch device 340 could be used as one style of clutch described in FIG. 1, FIG. 2, FIG. 7 and FIG. 8 as the clutch device 170 and 612. Clutch device modes 340a, and 340b are both the same clutch device 340 in different modes of operation. 340c is simply a cut-away side view of 340a. They will be referred to hereinafter as “mode(s)” (meaning mode of operation of clutch device 340). In mode 340a the clutch device is in a mode of disengagement, while mode 340b shows the clutch device in a mode of engagement.

In reference to mode 340a: clutch device 340 has an outer ring 350 which is coupled to shaft 165. There is also an inner ring 355 which is coupled to shaft 175. In this mode of disengagement, inner ring 355 will be spinning (in this case) “clockwise” faster than outer ring 350, and as long as this is the case actuator 360 (usually a spherical ball or a cylindrical shaped piece; in this embodiment a spherical ball bearing) allows the two rings 350 and 355 to spin at different speeds. However, when the rotational speed of outer ring 350 becomes greater (in this case in the clockwise direction) than inner ring 355, spring 356 (along with the natural rolling movement of actuator 360) forces actuator 360 into the position shown in mode 340b, wherein;

Now referring to mode 340b: (the mode of clutch 340 engagement), because of the shape of outer ring 350, the actuator 360 becomes tightly wedged between outer ring 350 and inner ring 355, forcing both rings 350 and 355 to rotate synchronously with each other. This in turn causes shafts 165 and 175 to also rotate synchronously with each other. If the rotational speed (in this case in the clock-wise direction) of inner ring 355 becomes greater than the rotational speed of ring 350, then the clutch device 340 will again go into a mode of disengagement as shown in mode 340a.

Now referring to FIG. 4. FIG. 4 is a cut-away side-view, showing a frictional type clutch device 170 known in the art. There is a mode 170a (disengagement mode), and mode 170b (engagement mode). Clutch device 170 consists of two frictional-type discs designated as 170c and 170d. Disc 170c is coupled to shaft 175 to receive and transfer rotational movement. Disc 170d is coupled to shaft 165 also to receive and transfer rotational movement. Referring to disengagement mode 170a, the clutch device is in a mode of disengagement wherein discs 170c and 170d are separated by any means known in the art. This separation allows disc 170c and disc 170d to spin/rotate freely from each other, and consequently the shafts 175 and 165 to also spin/rotate freely from each other; however when (now referring to engagement mode 170b) the two discs are frictionally engaged with each other, or being pressed together with some force, the clutch device 170 becomes in a mode of engagement wherein both discs 170c and 170d are forced to spin/rotate synchronously with each other, and therefore cause shafts 165 and 175 to also spin/rotate synchronously with each other.

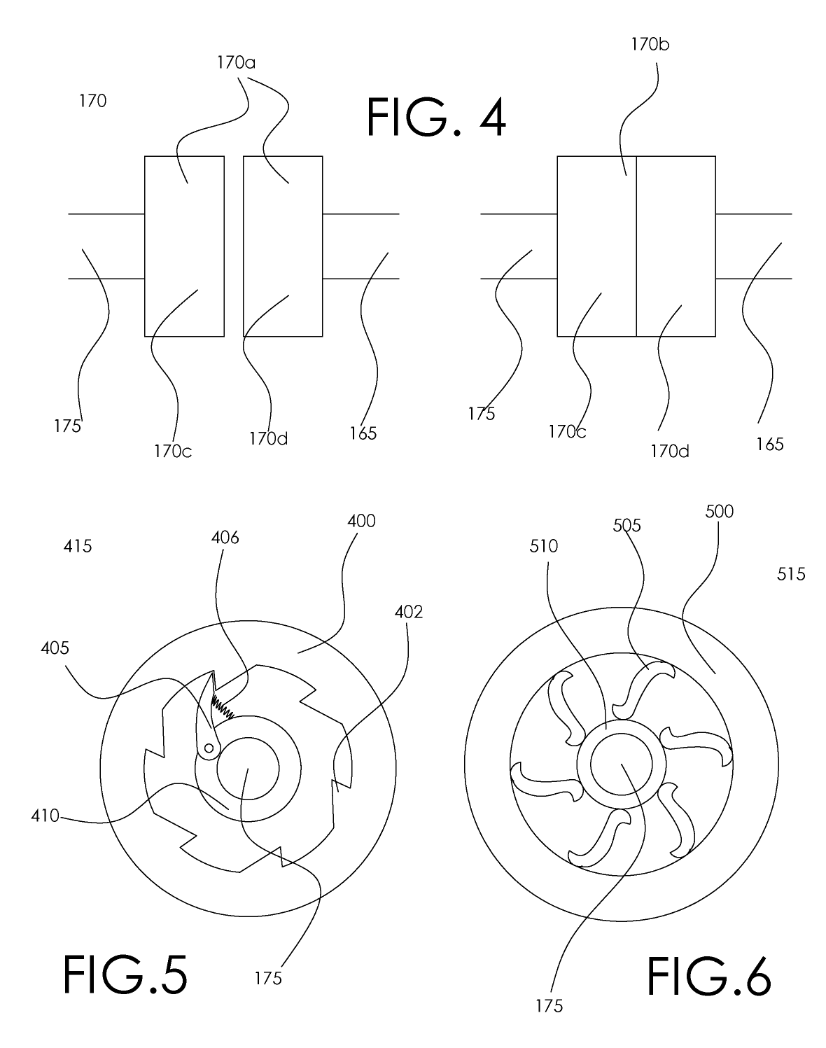

Now referring to FIG. 5. FIG. 5 shows a ratcheting type clutch 415, known in the art;

Whereas, there is an outer ring 400 having an inner face with cogs 402. An outer ring is coupled to a shaft 165 (hidden in this view). There is also an inner ring 410, which is coupled to shaft 175, in such a manner as to force ring 410 and shaft 175 to spin/rotate synchronously with each other. Inner ring 410 is pivotally attached to a strut 405. Said strut 405, is held against the inner face of the outer ring 400, such that the rotational speed of inner ring 410 is greater (counter-clockwise in this view, but could be opposite as well) than the rotational speed of outer ring 400, the strut will allow outer ring 400 to rotate at any speed (even in an opposite direction than inner ring 410) slower than inner ring 410, and consequently shaft 165 would be rotating slower than shaft 175 in this instance. However any time the rotational speed of outer ring 400 becomes greater (again in the counter-clockwise direction in this view) than the rotational speed of inner ring 410, strut 405 will catch on one of the cogs 402 and will force inner ring to spin/rotate at a synchronous speed to outer ring 400, and therefore shafts 175 and 165 at this time will also be spinning synchronously. At any time however the rotational speed of the outer ring 400 becomes less (in this case in the counter-clockwise direction) than the rotational speed of inner ring 410 the rings 400 and 410 will again spin at different speeds as described earlier.

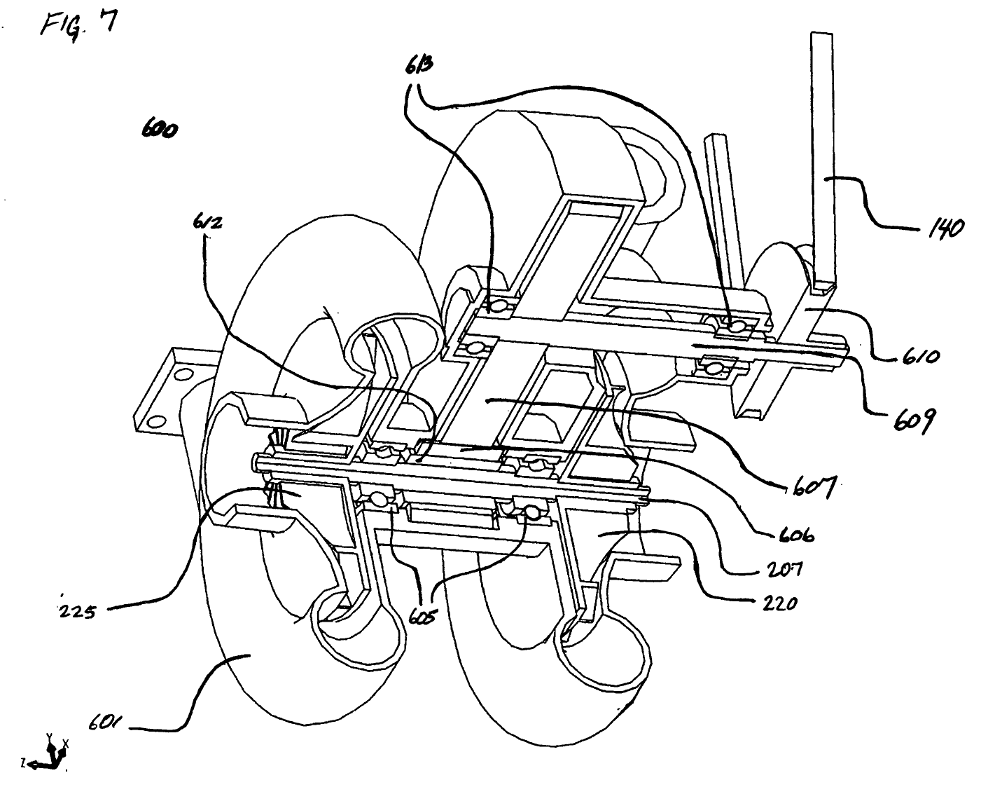

Now referring to FIG. 6. FIG. 6 shows a Sprague type clutch 515, known in the art;

Whereas, there is an outer ring 500 which is coupled to a shaft 165 (hidden in this view). There is also an inner ring 510, which is coupled to shaft 175, in such a manner as to force ring 510 and shaft 175 to spin/rotate synchronously with each other. The inner ring 510 and the outer ring 500 slideably touch a strut or struts 505. Said strut(s) 505, is(are) positioned such that if the inner ring 510's rotational speed is greater (counter-clockwise in this example, but could be opposite as well) than the outer ring 500's rotational speed, the strut(s) will allow outer ring 500 to rotate at any speed (even in an opposite direction than inner ring 510) slower than inner ring 510, and consequently shaft 165 would be rotating slower than shaft 175 in this instance. However, any time the rotational speed of outer ring 500 becomes greater (again in the counter-clockwise direction in this case) than the rotational speed of the inner ring 510, strut 505 becomes wedged between the inner ring 510 and the outer ring 500 and will force the inner ring to spin/rotate at a speed synchronous to the outer ring 500, and therefore shafts 175 and 165 at this time will also be spinning synchronously. At any time, however, the rotational speed of the outer ring 500 becomes less (in this case in the counter-clockwise direction) than the rotational speed of the inner ring 510, the rings 500 and 510 will again spin at different speeds as described earlier.

Now referring to FIG. 7, showing a cut-away view of a portion of a turbo lag reducer device, designated as 600. This view does not show the engine 300, or manifolds 30 and 35, but would nevertheless be connected in a manner known in the art to such. The engine 300, and manifolds 30 and 35, have intentionally been left out from this view to simplify the explanation and conception of this portion of the turbo lag reducer device.

In this preferred embodiment, there is a housing 601, which houses an impeller/compressor 220. The impeller/compressor 220 is mounted on or attached to a shaft 207, such that the shaft 207 and impeller/compressor 220 must rotate together. The shaft 207 is also attached to in a similar manner to the turbine 225. Thus, the turbine 225, shaft 207 and impeller/compressor 220 all must rotate together. The shaft 207 is mounted within bearings 605 (which in this drawing is shown as two bearings, but it may contain more or less, as long as the shaft 207 may rotate) by means known in the art of bearings, allowing the shaft 207 to rotate, thus allowing the turbine 225 and impeller/compressor 220 to rotate therewith. Also mounted on shaft 207, is a clutch device 612, being any clutch device known in the art, said clutch device 612 being the intermediary between shaft 207 and gear 606, allowing both times of engagement, and times of disengagement between gear 606 and shaft 207. In times of engagement, gear 606 and shaft 207 would be forced to rotate synchronously, but in times of disengagement gear 606 and shaft 207 would be able to rotate differently from each other. Gear 606 is rotatably driven by gear 607, in the manner known in the art of gears. Shaft 609 is mounted to gear 607 in a manner known in the art to allow and force each to rotate together. Shaft 609 is allowed to rotate within bearings 613, by means known in the art of bearings.

Belt 140 rotatably drives pulley 610, which forces shaft 609 to rotate, by virtue of shaft 609 being mounted/attached to pulley 610. This in turn forces the rotation of gear 607, which forcibly drives gear 606.

If clutch device 612 is in a mode of engagement (which would typically be when gear 606 is rotating at a higher speed/RPM than shaft 207), then shaft 207 would be forced to rotate at the same speed as clutch device 612. This would in turn cause the impeller/compressor to rotate at the same speed as gear 606 and shaft 207. This situation would typically occur (as discussed in FIG. 1 and FIG. 2 description) at the low load/low engine RPM scenario.

However, if clutch device 612 is in a mode of disengagement (which would typically be when shaft 207 (and consequently turbine 225 and impeller/compressor 207) were rotating at a higher speed/RPM than gear 606) then shaft 207 may rotate at speeds higher or independent of gear 606.

Now referring to FIG. 8, showing the same preferred embodiment as FIG. 7, but with the housing removed for ease of showing the individual parts. This view does not show the engine 300, or manifolds 30 and 35, or housings, but would nevertheless be connected in a manner known in the art to such, which have intentionally been left out from this view to simplify the explanation and conception of this portion of the turbo lag reducer device.

In this preferred, simplified, embodiment the parts and function are the same as that described for FIG. 7, so the explanation of the parts and function will not be repeated.

In both embodiments shown as FIG. 7 and FIG. 8, the clutch device 612 is located in a “preferred” location. However, this clutch device 612 may be located at any point between the internal combustion engine's output shaft (not shown in FIG. 7 or FIG. 8), and the impeller/compressor 220, so that the internal combustion engine (not shown in FIG. 7 or FIG. 8) may be either engaged or disengaged (as needed) from impeller/compressor 220.

What is claimed is as follows:

1. A system for reducing turbo lag and/or turbo delay in an engine having a combustion chamber, the system comprising;
a turbine positioned to be driven by exhaust gas from the combustion chamber;
an impeller configured to compress, and push, air for/to the combustion chamber;
the turbine operably coupled to the impeller to transfer rotational motion to the impeller a transmission device operably coupled to the engine to receive rotational motion and transfer rotational motion to the impeller;
so that the impeller is driven by the engine rotation through the transmission device one time and the impeller is driven by the turbine at another time different from the first time;
the impeller may also be driven by the turbine at one time, and the transmission device at another time different from the first time;
the impeller may also be driven by both the turbine and the transmission device simultaneously.

2. A turbo lag reducer device of claim 1, wherein by means of a shaft a clutch device and transmission device are operably connected to an impeller of a turbo charger;
wherein the impeller in the turbo charger is used commonly, and said impeller is driven both mechanically by said driving mechanism means (transferring the engine's rotation through the transmission device and clutch device), and by exhaust gasses from the engine's combustion chamber.

3. A turbo lag reducer device of claims 1 & 2 comprising:
a transmission device configured to be operably coupled to an engine so as to rotate an impeller air-compressor to produce a pressure greater than atmospheric pressure in the intake manifold of the engine;
said transmission device to have the ability to mechanically transfer rotational motion at or near a desired speed;
wherein said transmission device is used to control the ratio of revolution speed between the impeller and engine.

4. A turbo lag reducer device of claim 3 comprising:
an input portion which receives rotational movement from the engine;
an output portion which drives or outlets rotational movement from the engine;
a transmission device may consist of a single transmission device, or multiple transmission devices, using cables, gears, shafts, chains, sprockets, splines or any other means known in transmission devices, which control the ratio of revolution speed between its input and output portions.

5. A turbo lag reducer device of claims 1 & 2 further comprising:
a coupling clutch device which enables a common impeller air-compressing device to be driven at the faster of two speeds produced (1) by the exhaust driven turbine, and/or (2) transmission/engine-driven rotating portion.

6. A turbo lag reducer device of claims 1 & 2, wherein a clutch device may be:
a unidirectional or overriding clutch;
an electrical switch used in place of, or together with, a unidirectional or overriding clutch;
any other means known which may perform the same or similar functions;
whereby the clutch device is able to:
engage both rotational members together;
disengage either rotational member;
by engaging, disengaging or otherwise controlling the rotational members, allow one rotational member to supercede the other rotational member.

7. The turbo lag reducer device of claims 1 & 2 further comprising various connecting means configured to transfer such rotational motion from each said rotational member to each succeeding rotational member such that the revolutions per minute (RPMs) of the rotational motion thus transferred is either maintained or increased by some factor or ratio to that of the prior rotational member.

8. The turbo lag reducer device of claim 6 further comprising an overriding, engaging and/or disengaging means operatively connected to the preceding rotational member;
a connecting shaft or other means configured to transfer such rotational motion from the preceding rotational member to the clutch;
a connecting shaft or other means configured to transfer such rotational motion from said preceding rotational member to said clutch, such that the rotational motion is thus transferred, maintained and/or increased.

9. The turbo lag reducer device of claims 1 & 2, wherein by means of an output shaft said clutch is connected to an impeller of a turbo charger;
wherein the rotational motion of the turbo lag reducer moving from the clutch may be superceded by the rotational motion of the turbo charger produced by the exhaust flow from the engine when the rotational RPMs of said turbo charger produced by the flow of said exhaust gasses are greater than the RPMs of the rotational motion of the turbo lag reducer produced by said transmission/engine-driven device.

10. The turbo lag reducer device of claims 1 & 2 wherein by means of an output shaft said clutch is connected to an impeller of a turbo charger;
wherein the rotational motion of the turbo lag reducer moving from the clutch may at any time, and from time to time, supercede the rotational motion of the turbo charger produced by the flow of said exhaust gasses from the engine, when the rotational RPMs of said turbo lag reducer are greater than the RPMs of the rotational motion of the turbo charger, and then alternatively be superceded by the rotational motion of the turbo charger produced by the flow of exhaust gasses from the vehicle's engine when the rotational RPMs of said turbo charger produced by the flow of said exhaust gasses are greater than the RPMs of the rotational motion of the turbo lag reducer.

11. A turbo lag reducer device of claims 1 and 2, wherein by means of an output shaft said clutch is connected to an impeller of a turbo charger;
wherein multiplied rotational motion is mechanically transferred from the engine to power the turbo charger while the exhaust-driven process of said turbo charger is also continuing to operate (whether such exhaust-driven process has superceded the mechanically transferred rotational motion power, or is being superceded by said mechanically transferred rotational motion power).

12. A turbo lag reducer device of claims 1 and 2, wherein by means of an output shaft said clutch is connected to an impeller of a turbo charger;
wherein the normal exhaust-driven process of said turbo charger has superceded the mechanically transferred rotational motion's RPMs, and wherein the mechanically transferred rotational motion is also continuing to operate.

13. A turbo lag reducer device of claims 1 and 2, wherein by means of an output shaft said clutch is connected to an impeller of a turbo charger;
wherein the normal exhaust-driven process of said turbo charger has superceded the mechanically transferred rotational motion's RPMs, and wherein the mechanically transferred rotational motion is stopped.

14. A turbo lag reducer device of claims 1 and 2;
that produces and forces higher-than-atmospheric-pressured air to an engine's air intake manifold by both mechanically-driven and exhaust-driven means.

15. A turbo lag reducer device of claim 14 wherein two boosting means, mechanical and exhaust, are both used;
wherein said clutch device alternatingly causes the previously superceded, or overridden, boosting means to subsequently, and alternatingly, supercede, or override, the boosting means which had previously superceded, or overridden, the other boosting means.

16. A turbo lag reducer device, where there is an engine having a combustion chamber, the system comprising;
a turbine positioned to be driven by exhaust from the combustion chamber;
a driving mechanism operably coupled to the engine;
two separate impellers configured to compress air for the combustion chamber, wherein;
one impeller is operably coupled to the turbine and one impeller is operably coupled to a driving mechanism so that both impellers may be driven individually, but both contribute to the compressed air for the combustion chamber.

17. A turbo lag reducer device of claims 1 and 2;
wherein an impeller air-compressing device consists of multiple (more than one) impellers all working to accomplish the same task of compressing air for the combustion chamber.

18. A turbo lag reducer device of claims 1 and 2:
wherein exhaust gas turbine-driving device consists of multiple (more than one) turbines all being driven by engine exhaust gas, and coupled so they may drive the impeller.

19. A turbo lag reducer device of claims 1, 2 and 17;
wherein the engine may have either one (1) or multiple (more than one), combustion chamber(s).

20. A turbo lag reducer device of claims 1, 2 and 19;
wherein an engine with multiple combustion chambers, may have any number (from one to all) of the combustion chambers being provided with air from the lag reducer device, or providing the turbine with exhaust gas.

21. A turbo lag reducer device of claims 1 and 2, wherein said clutch device is part of said transmission device.

22. A turbo lag reducer device of claims 1, 2 and 21, wherein said transmission device transfers rotational motion to;
a shaft which connects said impeller and turbine together, and does so on said shaft in between impeller and turbine.

23. A turbo lag reducer device of claim 22 wherein;
said shaft which connects said impeller and turbine together has a clutch device directly mounted onto the shaft, and then mounting a gear directly onto clutch device, such that said gear is concentric with said shaft.

24. A turbo lag reducer device of claim 23 wherein;
said gear is mounted on shaft in between turbine and impeller.
